(19) United States
(12) Patent Application Publication
(10) Pub. No.: US 2010/0083480 A1
(43) Pub. Date: Apr. 8, 2010

(54) Method of Friction-Assisted Clinching

(75) Inventor: Jon T. Carter, Farmington, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/245,923

(22) Filed: Oct. 6, 2008

(51) Int. Cl. B23P 11/00

(52) U.S. Cl. 29/432

(57) ABSTRACT

A method of clinching includes contacting a punch to stacked workpieces and rotating the punch to generate frictional heat in the workpieces, and advancing the punch into the workpieces to form a mechanically-interlocking joint. Rotation of the punch may be stopped prior to advancing the punch into the stacked workpieces. The first workpiece may be formed from a first material and the second workpiece formed from a different, second material. One of the first and second materials may be magnesium or a magnesium alloy. The mechanically-interlocking joint is characterized by the absence of intermetallic compounds, and may be substantially hermetically sealed against passage of fluids and gasses. A hole may be formed in one of the workpieces and, prior to contacting the punch to the workpieces, the hole aligned substantially coaxially with the punch. Forming the mechanically-interlocking joint may include deforming both the first and second workpieces.

### TECHNICAL FIELD

This disclosure relates to a method of clinching two or more overlapping members.

### BACKGROUND OF THE INVENTION

Many structures, such as those in automotive vehicles, may require that metal sheets, tubes, or other profiles be attached to each other. Clinching is one potential method of attaching such sheets or tubes. Clinching typically includes stamping or otherwise cold forming corresponding indentations in at least two stacked metal sheets for mechanically interlocking the sheets to each other. Joints created by clinching do not require mechanical fasteners (bolts, screws, rivets, et cetera,) adhesives, or welds.

The clinching processes may require fairly substantial deformation of the sheets to form proper indentations. High strength metal sheets, which tend to be more brittle than lower strength metals, may not be suitable for cold forming, and may therefore be difficult to clinch at room temperature. Similarly, some light metal alloys, might not have enough ductility to be formable at room temperature.

### SUMMARY

A method of clinching is provided. The method includes contacting a punch stacked first and second workpieces, and rotating the punch to generate frictional heat in the workpieces. The punch is then advanced into the workpieces to form a mechanically-interlocking joint. Rotation of the punch may be stopped prior to advancing the punch into the stacked workpieces. Alternatively, rotation may be stopped after the punch has fully, or partially, advanced into the workpieces.

The first workpiece may be formed from a first material and the second workpiece formed from a different, second material. One of the first and second materials may be magnesium or a magnesium alloy. The mechanically-interlocking joint is characterized by the absence of intermetallic compounds forming between the first and second materials. The mechanically-interlocking joint may further be substantially hermetically sealed against passage of fluid and gas.

One embodiment of the claimed invention further includes forming a hole in the first workpiece or the second workpiece and, prior to contacting the punch to the workpieces, aligning the hole substantially coaxially with the punch. Forming the mechanically-interlocking joint may include deforming both the first and second workpieces. Advancing the punch into the workpieces includes laterally deforming either or both of the first workpiece or the second workpiece. In yet another embodiment, the punch includes a stub portion configured to effect lateral or radial deformation of the stacked workpieces during said advancing the punch into said stacked workpieces.

The above features and advantages and other features and advantages of the present invention are readily apparent from the following detailed description of the best modes and other embodiments for carrying out the invention when taken in connection with the accompanying drawings.

### BRIEF DESCRIPTION OF THE DRAWINGS

FIG. 1 is a schematic perspective view of a joining system and clinching apparatus, showing a significantly enlarged clinching apparatus for illustrative purposes;

FIG. 2A is a schematic cross-sectional view of the clinching apparatus shown in FIG. 1, showing the workpieces, punch assembly, and the die assembly during setup and heating phases of the friction-assisted clinching process;

FIG. 2B is a schematic cross-sectional view of the clinching apparatus in FIG. 2A, showing an intermediate or drawing phase as the punch advances into the workpieces;

FIG. 2C is a schematic cross-sectional view of the clinching apparatus in FIGS. 2A and 2B, showing a clinching phase during or after the workpieces have deformed radially or laterally to form the mushroom-shaped, interlocking mechanical clinch joint;

FIG. 3A is a schematic cross-sectional view of a different embodiment of a clinching apparatus in the setup and heating phase, showing a punch with a stub protrusion and one workpiece having a preformed hole generally coaxial with the punch;

FIG. 3B is a schematic cross-sectional view of the clinching apparatus shown in FIG. 3A, showing the clinching phase during or after one or both of the workpieces have radially deformed to form the interlocking mechanical clinch joint;

FIG. 4A is a schematic cross-sectional view of another embodiment of a clinching apparatus in the setup and heating phases, showing a punch with a stub protrusion and one workpiece having a preformed hole generally coaxial with the punch; and

FIG. 4B is a schematic cross-sectional view of the clinching apparatus shown in FIG. 4A, showing the clinching phase during or after one of the workpieces has deformed to form the interlocking mechanical clinch joint.

### DESCRIPTION OF PREFERRED EMBODIMENTS

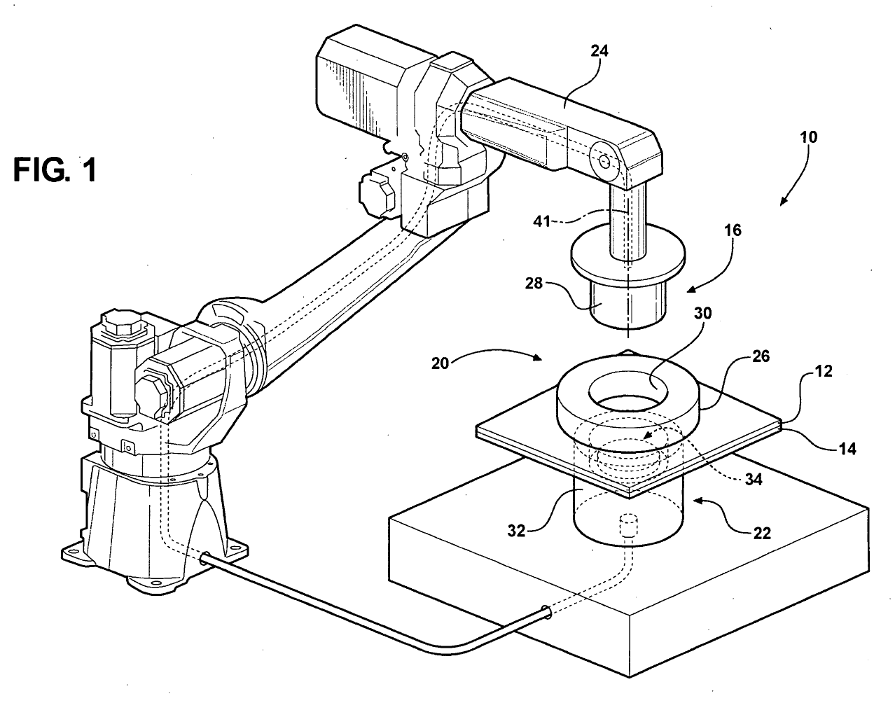

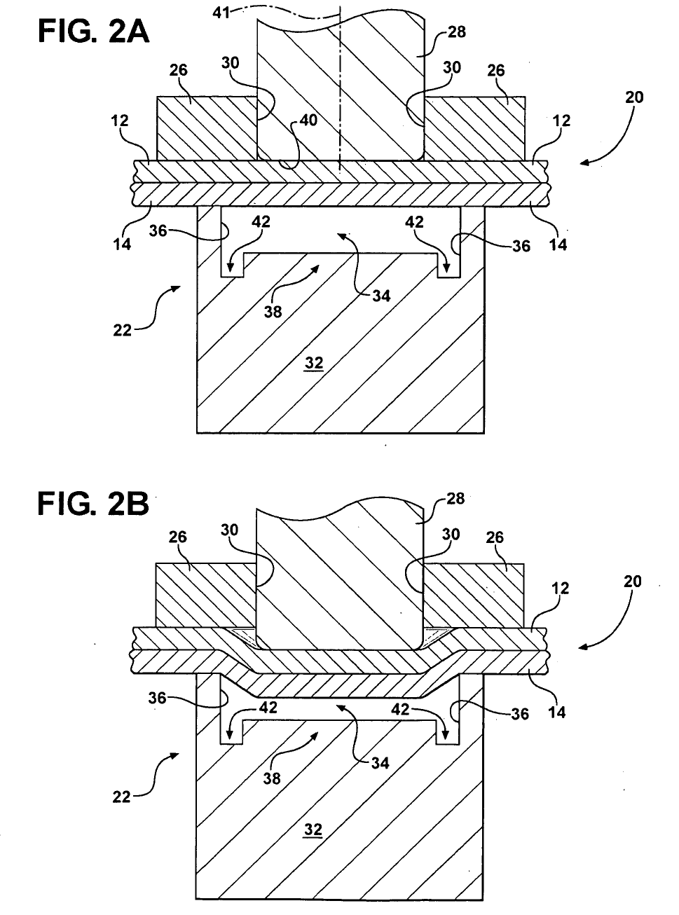

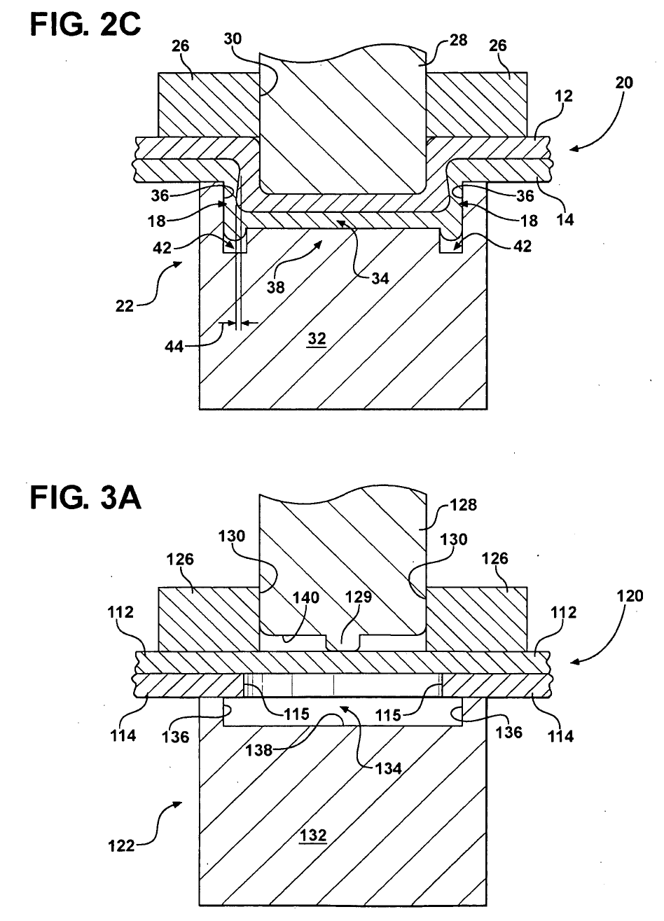

Referring to the drawings, wherein like reference numbers correspond to like or similar components throughout the several figures, there is shown in FIG. 1 one embodiment of a joining system 10. A first workpiece 12, in this embodiment a metal sheet, may be clinched to a second workpiece 14, also shown as a metal sheet in FIG. 1, by a clinching apparatus 20. The clinching apparatus 20 includes a punch assembly 16 configured to create or stamp an interlocking mechanical joint 18 (not shown in FIG. 1, see FIGS. 2A-2C and associated description) into the first and second workpieces 12 and 14, which are supported by a die assembly 22.

The first and second workpieces 12 and 14 may be sheets, tubes, partial cylinders, or more complex profiles, such as preformed panels or gaskets. Those having ordinary skill in the art will recognize that terms such as “above,” “below,” “upward,” “downward,” et cetera, are used descriptively of the figures, and do not represent limitations on the scope of the invention, as defined by the appended claims.

The punch assembly 16 and the die assembly 22, or both, may be mounted to various apparatuses for moving and supporting the punch assembly 16 or the die assembly 22 relative to each other. In the exemplary schematic embodiment shown in FIG. 1, the punch assembly 16 is attached to a robot arm 24 that can move the punch assembly 16 as needed or desired. For illustrative purposes, the clinching apparatus 20 shown in FIG. 1 is significantly enlarged relative to the robot 24.

In this embodiment, the die assembly 22 is stably positioned adjacent the robot arm 24. Those having ordinary skill in the art will recognize other support structures usable in conjunction with the joining system 10, such as C-frames or hard tooling. To allow movement of the clinching apparatus 20, a C-frame holding the clinching apparatus 20 may be supported by the robot arm 24, which could then move the clinching apparatus 20 relative to the workpieces 12 and 14 to create multiple mechanical joints 18 at different locations on the workpieces 12 and 14.

A retaining member 26 further supports the workpieces 12 and 14, and may be incorporated into the die assembly 22, the punch assembly 16, or other tooling structure of the clinching apparatus 20. A punch 28 is movable (generally downward and upward, as viewed in FIG. 1) by the punch assembly 16. In one embodiment of the claimed invention, the diameter of punch 28 may be 10 millimeters or less. Punch 28 may be moved hydraulically, mechanically, electrically, pneumatically or otherwise. Retaining member 26 may include a path or guide hole 30 (shown in phantom in FIG. 1) to guide the punch 28 as it moves upward and downward against the workpieces 12 and 14.

FIGS. 2A-2C depict a more-detailed, cross-sectional view of the clinching apparatus 20 shown in FIG. 1. FIGS. 2A-2C show this embodiment of the clinching apparatus 20 at selected stages of a process of friction-assisted clinching of the workpieces 12 and 14.

In the embodiment shown in FIGS. 2A-2C, the die assembly 22 includes a die 32 having a die cavity 34, which is generally opposite, and coaxial with, the punch 28. Die cavity 34 has an outer wall 36 and a base portion 38, which will are configured to operate in conjunction with a face 40 of the punch 28 to form the mechanical joint 18, as described below.

Die cavity 34 may be coaxial with the punch 28, and the outer wall 36 of die cavity 34 may have a similar geometry to the punch 28. However the die cavity 34 and punch 28 need not share similar or substantially similar geometry; for example, and without limitation, the punch 28 may be generally cylindrical and the die cavity 34 may be generally rectangular.

In this embodiment, the punch 28 and die cavity 34 are both generally cylindrical. Note however, that the floor or base portion 38 of the die cavity 34 does not exactly match the face 40 of the punch 28. The base portion 38 includes a groove 42 configured to induce lateral deformation during the clinching process, as described below. In the embodiment of FIGS. 2A-2C, the die 32 is a fixed or static die, which does not incorporate movable walls or other moveable portions. Moveable dies may include, for example, sectional walls that induce lateral deformation by laterally or radially expanding the die cavity during the clinching process.

FIG. 2A shows the clinching apparatus 20 as the workpieces 12 and 14, the punch assembly 16, and the die assembly 22 are positioned or setup for the clinching process. The retaining member 26 is configured to assist in securing the workpieces 12 and 14 to the die assembly 22, and may also be configured to restrain vertical deformation during the clinching process. Furthermore, retaining member 26 may be configured to help strip the workpieces 12 and 14 off of the punch 28 when the punch 28 is retracted vertically.

FIG. 2A also shows the clinching apparatus as it begins to generate frictional heat in the stacked workpieces 12 and 14. The punch assembly 16 causes the punch 28 to rotate about an axis 41, which causes friction-induced heat along the contact zone between the face 40 and the top of first workpiece 12. The rotation may begin after, simultaneously with, or prior to the positioning of the workpieces 12 and 14 in the clinching apparatus 20 and the lowering of the punch 28 into contact with the workpiece 12 and 14.

The frictional heat generated by rotation of the punch 28 softens the material of either the first (top) workpiece 12, the second (bottom) workpiece 14, or both. This heat may increase the formability of metals or other materials which lack ductility at room temperature. Furthermore, the increased ductility reduces the force required to advance the punch 28 into the workpieces 12 and 14. Alternatively, friction may be generated by reciprocating linear movement of the punch 28 over the surface of workpiece 12. Furthermore, the punch 28 need not rotate continuously in a single direction, but may instead alternate or oscillate between rotational directions.

Non-ductile materials subjected to a room temperature clinching process may otherwise be susceptible to fractures, fatigue-sensitive regions, residual stresses, reduced durability, or other conditions—in or around the mechanical joint 18—which may not be acceptable for the final product. Increased temperature reduces the yield strength of the material, which may increase ductility and reduce formation of fractures or other imperfections.

Material temperature of the workpieces 12 and 14 may be monitored with sensors (not shown,) such that the rotation may be continued until a predetermined target temperature of one or both of the workpieces 12 and 14 is reached. Alternatively, rotation of the punch 28 may continue for a predetermined time period and then halted. The time period of punch 28 rotation may be calculated to raise the temperature of the workpieces 12 and 14 to the predetermined target temperature, or enough to negate non-ductility at room temperature. Furthermore, rotation may be controlled based upon other criteria; for example, by measuring the resistance exerted by the workpieces 12 and 14 on the punch 28, decreasing levels of which may signify that the workpieces 12 and 14 are softening.

The amount of heat generated by rotation of the punch 28 against the stacked workpieces 12 and 14 is partially a function of the force between the first workpiece 12 and the face 40, the contact area, the coefficient of friction, and the rate of rotation of the punch 28. The thickness and material composition of the workpieces 12 and 14 also affect the distribution of heat and the temperature gradient reached as a result of rotation of the punch 28.

FIGS. 2B and 2C show the clinching apparatus 20 as the punch 28 advances into the stacked workpieces 12 and 14 to form the clinch, which is the interlocking mechanical joint 18 (the clinch). FIG. 2B shows the punch 28 drawing the workpieces 12 and 14 into the die cavity 34, and FIG. 2C shows the workpieces 12 and 14 during or after they have deformed laterally or radially to form the clinch.

Following the clinching stage, the punch 28 is withdrawn (upward, as viewed in the figures) from the stacked workpieces 12 and 14, leaving an air-tight, water-tight mechanical joint 18. Those having ordinary skill in the art will recognize that, while only one mechanical joint 18 is shown, the clinching process could be repeated on the same workpieces 12 and 14, by moving the workpieces 12 and 14 between oscillations of the punch 28, to form other mechanical joints 18. Furthermore, the joining system 10 could be configured with multiple clinching apparatuses 20 arranged in a pattern or array to clinch the workpieces 12 and 14 in multiple locations and form multiple mechanical joints 18 in a single manufacturing process.

Depending upon the specific application of the clinched workpieces 12 and 14, rotation of punch 28 may be stopped prior to advancing the punch 28 into the workpieces 12 and 14, or rotation may continue during the drawing and/or clinching phases (as shown in FIGS. 2B and 2C, respectively). As shown in FIG. 2B, as punch 28 begins advancing downward into the stacked workpieces 12 and 14, the material of both the first and second workpieces 12 and 14 begin to deform—largely axially—into the die cavity 34.

At this drawing stage, the workpieces 12 and 14 are interlocked horizontally or laterally (as viewed in FIG. 2B) but may not be interlocked vertically and could still be separated. In embodiments where rotation is continued during the drawing phase, the workpieces 12 and 14 will continue to increase temperature.

As shown in FIG. 2C, clinching occurs as the punch 28 advances fully into the die cavity 34. The depth to which punch 28 advances will depend, among other factors, upon the materials chosen for workpieces 12 and 14, the size and geometry of the die cavity 34, and the amount of frictional heat generated by rotation of punch 28.

The final clinch shape, and thus the sealed, interlocking mechanical joint 18, occurs as the material of workpieces 12 and 14 radially deforms to form a mushroom or undercut portion 44. Radial deformation occurs as the workpieces 12 and 14 fill the base portion 38 and outer wall 36 portion of the die cavity 34. At this stage, the material is forced to deform radially outward from the center of base portion 38 into the groove 42. Alternatively, radial deformation may be induced by forcing the material move further outward rather than axially downward; such as with wider radial grooves or a spring-loaded split collet which moves the outer wall 36 radially.

A contact surface 46 between the workpieces 12 and 14 extends as a generally consistent surface throughout the mechanical joint 18, with little or no mixing or stirring of material between workpieces 12 and 14. Contact surface 46 lacks the coalescence of welded joints and mechanical joint 18 remains solely a mechanical connection because the workpieces 12 and 14 are not fused together. As shown in FIG. 2C, the contact surface 46 may be characterized by one or more inflection points—or points at which the curvature changes from convex to concave or vice versa—in the undercut portion 44.

Radial deformation allows the undercut portion 44 to form, thereby interlocking the workpieces 12 and 14 both horizontally and vertically. Due at least partially to formation of the undercut portion 44, the joining system 10 and clinching apparatus 20 do not require that either workpiece 12 or 14 have preformed grooves, ridges, notches, or other preformed locking structures. Furthermore, the clinching apparatus 20 shown in FIGS. 2A-2C may not require precision alignment of the workpieces 12 and 14 prior to clinching, because the mechanical joint 18 is formed without the use of a preformed hole in one of the workpieces 12 or 14.

The clinching apparatus 20, and the friction-assisted clinching process described herein, may be used to clinch workpieces 12 and 14 formed from any of several materials which lack ductility at room temperature. Possible materials include, without limitation: magnesium or magnesium alloys, high strength steel, and other materials recognized as suitable by those having ordinary skill in the art. For exemplary purposes, clinching aluminum and magnesium alloys will be discussed in further detail. Some aluminum and aluminum alloys may be clinchable at room temperature. However, frictional heat may assist the clinching process by reducing the force required to clinch aluminum or aluminum alloys.

Magnesium alloys have limited formability at room temperature. Clinching magnesium at room temperature may cause strains greater than the inherent ductility of the sheet, and may result in cracks in the mechanical joint 18. However, the ductility may be increased, and the yield strength can be lowered, by raising the temperature of the magnesium in the vicinity of the die cavity 34. Depending upon the specific magnesium alloy used, temperatures at or above 200-300 degrees Celsius may be sufficient to improve formability of the magnesium to form a durable mechanical joint 18 during the friction-assisted clinching process. Rotation of the punch 28 may, therefore, be stopped once the magnesium workpiece (either 12 or 14, or both) reaches a predetermined temperature at or above 200-300 degrees Celsius.

Similarly, cold forming of some aluminum alloys may be result in excess stress levels. Additionally, welding of some aluminum alloys is possible, but the high heat required to melt the aluminum in the weld zone often causes hot cracking in adjoining regions of the material and may affect heat treatment properties of the alloyed metal in and around the weld zone.

Further complications may arise when bonding two different materials. Welding magnesium and aluminum causes brittle intermetallic compounds to form in, and around, the weld zone. Significant melting or significant stirring or mixing of the two metals at high temperatures may have a similar result.

Intermetallic compounds may significantly weaken the joint. By creating a contact surface 46 which does not melt, mix, or stir the materials of workpieces 12 and 14, the friction-assisted clinching process of the clinching apparatus 20 does not create intermetallic compounds.

While temperature increases caused by rotation of the punch 28 are configured to assist the clinching process, it may also be beneficial to control the maximum temperature induced in the workpieces 12 and 14 before and during formation of the mechanical joint 18. High temperature gradients may result in cracking caused by thermal stresses along, and outside of, the clinched region. Furthermore, excessively high temperatures may remove heat treatments from the alloyed magnesium or aluminum and create large annealed regions in the workpieces 12 and 14.

Excessive temperature at the contact surface 46 between workpieces 12 and 14 may promote formation of brittle intermetallic compounds as elements of the alloys migrate across the contacting surface 46 of the workpieces 12 and 14, even where the temperature remains below the melting point of the materials. However, limiting the temperature of the workpieces 12 and 14 during the friction-assisted clinching process may mitigate, or even prevent, these effects.

The clinching process performed by the clinching apparatus 20 and the resulting mechanical joint 18 described herein differ from joints created by stir welding in several respects. Stir welding has extensive material interaction along and across the contact zone, which precludes formation of a defined contact surface. This interaction is likely to result in formation of brittle intermetallic compounds when differing materials are used. The lack of a consistent, defined surface (such as the contact surface 46 produced by the friction-assisted clinching process) occurs due to the stirring and mixing caused by stir welding.

Stir welding may also result in localized melting of the material, which may result in brittle intermetallic compounds, hot-cracking, or other problems caused by excessive heat and stirring of material in the workpieces. The joining system 10 does not utilize transverse movement (which would be generally into, and out of, the view shown in FIGS. 1 and 2A-2C) along the workpieces 12 and 14. Joining system 10 and clinching apparatus 20 use an oscillatory (up and down) punching movement to form mechanical joint 18. Furthermore, stir welding does not form the undercut portion 44 (mushroom).

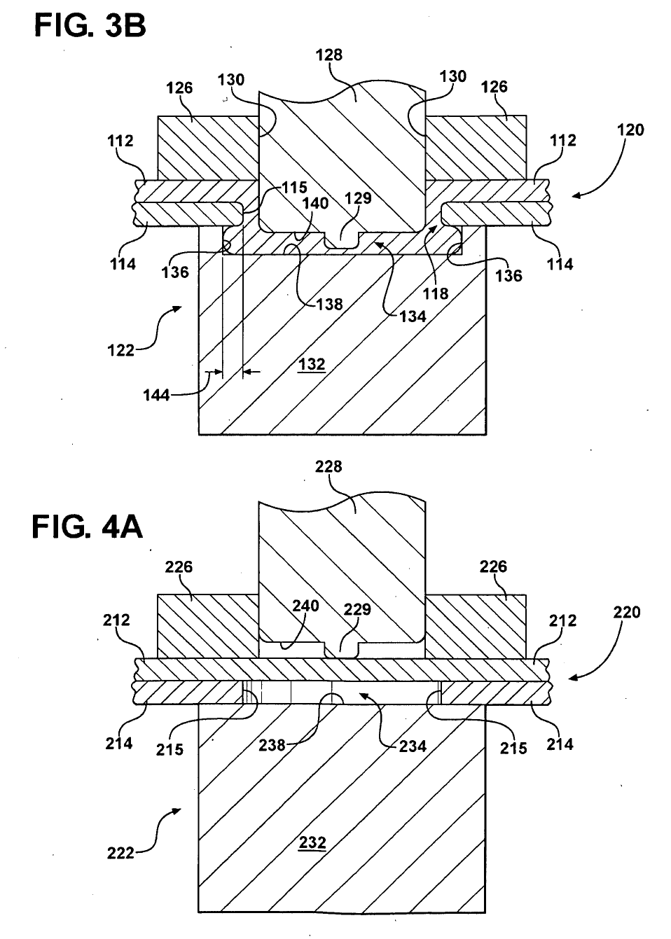

Referring now to FIGS. 3A and 3B, there is shown an alternative embodiment of a clinching apparatus 120 which may be used with the joining system 10 shown in FIG. 1 to carry out a friction-assisted clinching process. The embodiment shown in FIGS. 3A and 3B is configured with a different geometry than the clinching apparatus shown in FIGS. 2A-2C.

As shown in FIG. 3A, first and second workpieces 112 and 114, respectively, are held between a die assembly 122 having a die 132 and a retaining member 126 having a guide hole 130. The second workpiece 114 includes a preformed hole 115 drilled, pierced, or otherwise formed therein. The preformed hole 115 is aligned generally coaxially with a punch 128 and a die cavity 134, which has an outer wall 136 and a base portion 138. In the embodiment shown in FIGS. 3A and 3B, the base portion 138 is generally flat. However, the base portion 138 could include a groove similar to the groove 42 shown in FIGS. 2A-2C.

The punch 128 includes a face 140 having a stub 129 protruding therefrom. During a heating stage, after the punch 128 contacts the first workpiece 112, the punch 128 is rotated to generate frictional heat in the first workpiece 112. Depending upon the application, the punch 128 may dwell and rotate with the stub 129 in contact with the first workpiece 112, dwell and rotate with the face 140 in contact with the first workpiece 112, or may have two dwell stages utilizing both stub 129 and face 140. The stub 129 may have a flat end, a pointed end, a rounded end, a bulleted end, or other shapes.

First workpiece 112 may be formed from aluminum and the second workpiece 114 formed from magnesium. In this configuration, the material with higher ductility (aluminum) undergoes more deformation than the material with lower ductility (magnesium). Such a configuration may reduce the energy required to form a mechanical joint 118 which vertically and horizontally locks the workpieces 112 and 114.

By preforming hole 115 in the lower, less-ductile workpiece 114, the workpiece 114 may not have to deform at all during clinching. The upper workpiece 112 could be either a ductile or non-ductile material, and gets frictionally heated to reduce strength and increase ductility so that it may flow through the hole 115 in the lower workpiece 114.

As the punch 128 advances into the die cavity 134, the material of the first workpiece 112 adjacent to the preformed hole 115 deforms into the die cavity 134. As the first workpiece 112 contacts the base portion 138, material is deformed laterally under the edges of second workpiece 114 and is pressed against the outer wall 136 to form an undercut portion 144. Note that the stub 129 further assists this process by forcing material in the center of the die cavity 134 to deform outward from the center. In addition, the stub 129 helps keep the rotating punch 128 stably contacting and centered on the workpiece 112.

In the embodiment shown, the overhang or undercut portion 144 is formed largely of the first workpiece 112, although some deformation of the second workpiece 114 may also occur. However, by adjusting the configuration of the clinching apparatus, the undercut portion 144 and mechanical joint 118 may be formed by substantially deforming both the first and second workpieces 112 and 114. Factors that may be adjusted to affect deformation of the workpieces 112 and 114 include, but are not limited to: the overhang of preformed hole 115 relative to the outer wall 136, the temperature level reached during the frictional heating phase, the depth and shape of die cavity 134, the width of the punch 128 and stub 129, and the materials from which the first and second workpieces 112 and 114 are formed.

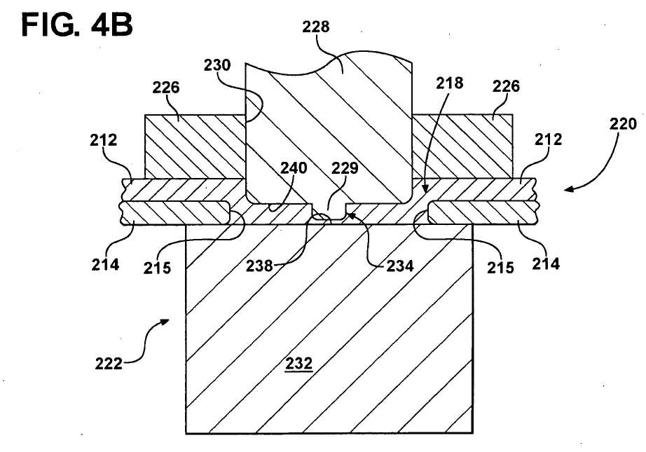

Referring now to FIGS. 4A and 4B, there is shown another alternative embodiment of a clinching apparatus 220 which may be used with the joining system 10 shown in FIG. 1 to carry out a friction-assisted clinching process. The embodiment shown in FIGS. 4A and 4B is also configured with a different geometry than the clinching apparatus shown in FIGS. 2A-2C.

As shown in FIG. 4A, first and second workpieces 212 and 214, respectively, are held between a die assembly 222 having a die 232 and a retaining member 226 having a guide hole 230. Similar to the second workpiece 114, the second workpiece 214 shown in FIGS. 4A and 4B includes a preformed hole 215 drilled, pierced, or otherwise formed therein. The preformed hole 215 is aligned generally co axially with a punch 228. In this embodiment, a die cavity 234 is formed largely by the preformed hole 215 and a base portion 238, and does not include an outer wall.

The punch 228 includes a face 240 having a stub 229 protruding therefrom. During a heating stage, after the punch 228 contacts the first workpiece 212, the punch 228 is rotated to generate frictional heat in the first workpiece 212. Depending upon the application, the punch 228 may dwell and rotate with the stub 229 in contact with the first workpiece 212, dwell and rotate with the face 240 in contact with the first workpiece 212, or may have two dwell stages utilizing both stub 229 and face 240.

As the punch 228 advances into the die cavity 234, the material of the first workpiece 212 adjacent to the preformed hole 215 deforms into the die cavity 234. As the first workpiece 212 contacts the base portion 238, material is deformed laterally and pressed against the edges of preformed hole 215 to form a mechanical joint 218. Note that the stub 229 further assists this process by forcing material in the center of the die cavity 234 to deform outward. The degree of mechanical interlocking shown in FIG. 4A is less than that shown in FIG. 3B. However, the resulting mechanical joint 218 is smooth or flush on the die (232) side. The degree of mechanical interlocking will depend on the configuration and roughness of the wall of hole 215.

Another embodiment (not shown) may incorporate the features and components of the clinching apparatus 20 shown in FIGS. 2A-2C, with the addition of a stub (not shown) on face 40 of the punch 28. The stub would further create lateral deformation of the first and second workpieces 12 and 14, and assist in creation of the mechanical joint 18. During the clinching process, a small diameter stub may also reduce the tendency of the face 40 to move laterally when it contacts the first workpiece 12 and rotates to generate frictional heat.

The method and apparatus described herein may be used for attaching several different automotive components that have metal sheets, plates, tubes, or other portions suitable for clinching. Examples, without limitation, include: peel joints, lap joints, and various vehicle panels such as door panels, deck lids, hoods, and sunroof applications.

While the best modes and other embodiments for carrying out the claimed invention have been described in detail, those familiar with the art to which this invention relates will recognize various alternative designs and embodiments for practicing the invention within the scope of the appended claims.

1. A method of clinching a first workpiece and a second workpiece, stacked such that at least a portion of the first workpiece overlaps at least a portion of the second workpiece, comprising:
contacting a punch to the stacked workpieces;
rotating the punch to generate frictional heat in the stacked workpieces; and
advancing the punch into the stacked workpieces to form a mechanically-interlocking joint.

2. The method of claim 1, further comprising stopping said rotating of the punch prior to said advancing the punch into the stacked workpieces.

3. The method of claim 2, wherein the first workpiece is formed from a first material and the second workpiece is formed from a second material different from said first material.

4. The method of claim 3, wherein one of said first and second materials is one of magnesium and a magnesium alloy.

5. The method of claim 4, wherein said mechanically-interlocking joint is characterized by the absence of intermetallic compounds.

6. The method of claim 5, wherein said mechanically-interlocking joint is substantially hermetically sealed against passage of fluid and gas.

7. The method of claim 6, further comprising:
forming a hole in one of the first workpiece or the second workpiece; and
aligning the hole substantially coaxially with the punch prior to said contacting the punch to the workpieces.

8. The method of claim 7, wherein said forming of said mechanically-interlocking joint includes deforming both the first workpiece and the second workpiece.

9. The method of claim 8, wherein said advancing the punch into the workpieces includes laterally deforming the first workpiece and the second workpiece

10. A method of clinching, comprising:
stacking a first workpiece formed from a first material and a second workpiece formed from a second material different from said first material, such that at least a portion of the first workpiece overlaps at least a portion of the second workpiece;
placing the stacked workpieces between a punch and a stationary die;
contacting the punch to the stacked workpieces;
generating frictional heat between the stacked workpieces and the punch;
after said generating frictional heat, advancing the punch into the stacked workpieces and deforming both the first workpiece and the second workpiece to form a mechanically-interlocking joint; and
retracting the punch from said formed mechanically-interlocking joint.

11. The method of claim 10, wherein said generating frictional heat includes rotating the punch.

12. The method of claim 11, further comprising stopping rotating the punch prior to said advancing the punch into the stacked workpieces.

13. The method of claim 10, wherein one of said first and second materials is one of magnesium and a magnesium alloy.

14. The method of claim 10, wherein said formed mechanically-interlocking joint is characterized by the absence of intermetallic compounds.

15. The method of claim 10, further comprising:
forming a hole in one of the first workpiece or the second workpiece; and
aligning the hole substantially coaxially with the punch prior to said contacting the punch to the workpieces.

16. A method of clinching, comprising:
stacking a first workpiece and a second workpiece;
placing said stacked workpieces between a punch and a stationary die;
contacting the punch to said stacked workpieces;
rotating the punch to generate frictional heat in said stacked workpieces;
stopping rotation of the punch after said frictional heat causes said stacked workpieces to reach a predetermined temperature;
advancing the punch into said stacked workpieces to form a mechanically-interlocking joint; and
retracting the punch from said mechanically-interlocking joint.

17. The method of claim 16, further comprising:
forming a hole in one of the first workpiece or the second workpiece; and
aligning the hole substantially coaxially with the punch prior to said contacting the punch to the workpieces.

18. The method of claim 17, wherein the first workpiece is formed from a first material and the second workpiece is formed from a second material different from said first material.

19. The method of claim 18, wherein one of said first and second materials is one of magnesium and a magnesium alloy.

20. The method of claim 16, wherein the punch includes a stub portion configured to effect lateral deformation of said stacked workpieces as during said advancing the punch into said stacked workpieces.
